(19) United States
(12) Patent Application Publication
(10) Pub. No.: US 2014/0248827 A1
(43) Pub. Date: Sep. 4, 2014

(54) Aircraft Circulation System for Passenger Cabins

(71) Applicant: THE BOEING COMPANY, Chicago, IL (US)

(72) Inventors: Andrew P. Keleher, Snohomish, WA (US); Gregory T. Eisele, Everett, WA (US)

(73) Assignee: The Boeing Company, Chicago, IL (US)

(21) Appl. No.: 13/783,664

(22) Filed: Mar. 4, 2013

(51) Int. Cl. B64D 13/00

(52) U.S. Cl. CPC B64D 13/00
USPC 454/76

(57) ABSTRACT

A method and apparatus for an air circulation system. The apparatus comprises a suite and a circulation unit. The suite has walls extending upward from a floor of the passenger cabin without reaching a ceiling of the passenger cabin. The circulation unit comprises an inlet system configured to receive air in the passenger cabin of an aircraft in a location outside of the suite; an outlet system configured to output the air received by the inlet system into an interior of the suite; and a fan system configured to cause a movement of the air into the inlet system from outside of the suite and out of the outlet system into the interior of the suite. The air moves upwards in the suite and over the walls. The air moving over the walls causes a desired circulation of the air within the passenger cabin.

### BACKGROUND INFORMATION

1. Field

The present disclosure relates generally to aircraft and, in particular, to environmental systems in aircraft. Double particular, the present disclosure relates to a method and apparatus for circulating air in a passenger cabin of an aircraft.

2. Background

The environmental control system of an aircraft controls the air supply, temperature, and pressure in the aircraft. In managing the air supply, areas such as the passenger cabin are designed to circulate air within the passenger cabin.

With respect to circulating air, vents, grills, ducts, fans and other devices are located within and around the passenger cabin. The passenger cabin is typically open and air circulates freely within the passenger cabin without obstructions.

In some aircraft, suites are provided within the cabin. Suites may be found in first-class passenger cabins. These suites are private sitting areas. A suite may provide a private seating area for one or more persons. This private sitting area may be formed by installing walls in a passenger cabin. These walls may cover three or more sides to provide a desired level of privacy and passenger comfort.

A suite typically has two doors that move to open and close. The presence of suites in the passenger cabin, however, may reduce the flow of air that circulates within the passenger cabin. The height of the walls and the suite doors affect the flow of air in the entire passenger cabin. As a result, air stagnation and temperature stratification may occur within the suite, in the aisles outside of the suite, and in other areas of the passenger cabin.

Currently, a suite may have louvers on the doors to provide for ventilation of air. Additionally, the suite also may include one or more gasper air outlets. These currently used mechanisms, however, often do not provide a desired circulation within the passenger cabin. Therefore, it would be desirable to have a method and apparatus that takes into account at least some of the issues discussed above, as well as other possible issues.

### SUMMARY

In one illustrative embodiment, an air circulation system for a passenger cabin comprises a suite and a circulation unit. The suite has walls extending upward from a floor of the passenger cabin without reaching a ceiling of the passenger cabin. The circulation unit comprises an inlet system configured to receive air in the passenger cabin of an aircraft in a location outside of the suite; an outlet system configured to output the air received by the inlet system into an interior of the suite; and a fan system configured to cause a movement of the air into the inlet system from outside of the suite and out of the outlet system into the interior of the suite. The air moves upwards in the suite and over the walls. The air moving over the walls causes a desired circulation of the air within the passenger cabin.

In another illustrative embodiment, an apparatus comprises an inlet system, an outlet system, and a fan system. The inlet system is configured to receive air in a passenger cabin of an aircraft in a location outside of a suite. The outlet system is configured to output the air received by the inlet system into an interior of the suite. The fan system is configured to cause a movement of the air into the inlet system and out of the outlet system. The movement of the air causes a desired circulation of the air in the passenger cabin.

In yet another illustrative embodiment, a method for circulating air is provided. Air is moved in the passenger cabin from an exterior of a suite into an inlet system associated with the suite. The air received is moved by the inlet system into an interior of the suite through an outlet system associated with the suite. A movement of the air causes a desired circulation of the air in the passenger cabin.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of an air circulation environment in accordance with an illustrative embodiment;

FIG. 3 is an illustration of an inlet system in accordance with an illustrative embodiment;

FIG. 4 is an illustration of an outlet system in accordance with an illustrative embodiment;

FIG. 5 is an illustration of a fan system in accordance with an illustrative embodiment;

FIG. 6 is an illustration of an exterior view of a suite in accordance with an illustrative embodiment;

FIG. 7 is another illustration of an exterior view of a suite in accordance with an illustrative embodiment;

FIG. 8 is an illustration of an interior view of a suite in accordance with an illustrative embodiment;

FIG. 9 is another illustration of an interior view of a suite in accordance with an illustrative embodiment;

FIG. 10 is an illustration of a circulation unit in accordance with an illustrative embodiment;

FIG. 11 is another illustration of a circulation unit in accordance with an illustrative embodiment;

FIG. 12 is a cross-sectional view of a suite within an aircraft in accordance with an illustrative embodiment;

FIG. 13 is an illustration of flowchart of a process for circulating air in a passenger cabin in accordance with an illustrative embodiment;

FIG. 14 is an illustration of an aircraft manufacturing and service method in accordance with an illustrative embodiment; and

FIG. 15 is an illustration of an aircraft in which an illustrative embodiment may be implemented.

### DETAILED DESCRIPTION

The illustrative embodiments recognize and take into account one or more different considerations. Illustrative embodiments recognize and take into account that the louvers in the doors of a suite do not provide for active movement of air. Any airflow through the louvers is passive and may not provide a desired level of circulation of air in the passenger cabin.

Additionally, the illustrative embodiments also recognize and take into account that the gasper air outlets are designed for providing airflow to the face of a passenger or some other portion of the passenger. These gasper air outlets are not designed to facilitate airflow within the passenger cabin in a manner that provides desired circulation of air.

Thus, the illustrative embodiments provide a method and apparatus for circulating air in a passenger cabin. In one illustrative embodiment, an apparatus comprises an input system, an outlet system, and a fan system. The inlet system is configured to receive air in a passenger cabin of an aircraft in a location outside of a suite. The outlet system is configured to output air received by the inlet system into the interior of the suite. The fan system is configured to cause the movement of the air into the inlet system and out of the outlet system. The movement of the air causes a desired circulation of air within the passenger cabin.

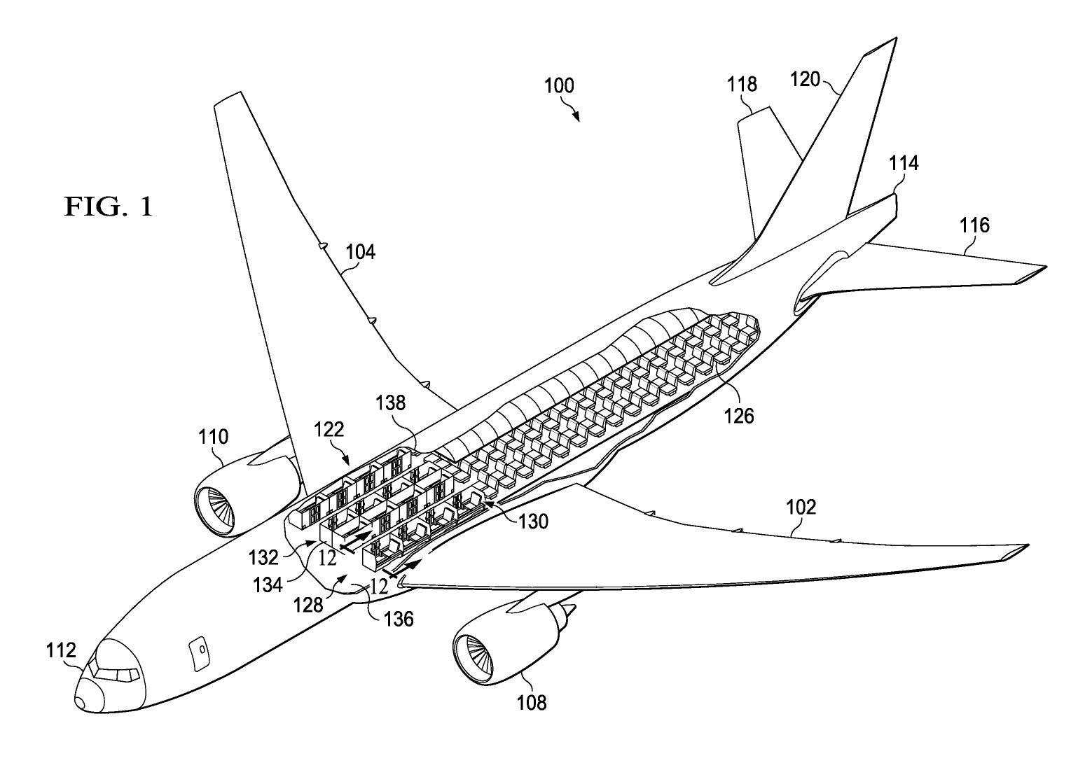

With reference now to the figures, and in particular, with reference to FIG. 1, an illustration of an aircraft is depicted in accordance with an illustrative embodiment. In this illustrative example, aircraft 100 has wing 102 and wing 104 attached to body 106. Aircraft 100 includes engine 108 attached to wing 102 and engine 110 attached to wing 104.

Body 106 has nose section 112 and tail section 114. Horizontal stabilizer 116, horizontal stabilizer 118, and vertical stabilizer 120 are attached to tail section 114 of body 106.

In this illustrative example, passenger cabin 122, passenger cabin 124 and passenger cabin 126 are shown in an exposed view of aircraft 100. As depicted, passenger cabin 122 is a first-class passenger cabin and includes suites 128 in addition to seats 130.

In this illustrative example, suites 128 are private sitting areas located in passenger cabin 122. These private sitting areas may seat one or more passengers.

For example, suite 132 includes a seat (not shown) surrounded by walls 134. Walls 134 extend upward from floor 136 of passenger cabin 122 without reaching ceiling 138 in passenger cabin 122.

In the illustrative examples, an air circulation system may be implemented within passenger cabin 122. The air circulation system may provide a desired circulation of air within passenger cabin 122 containing suites 128.

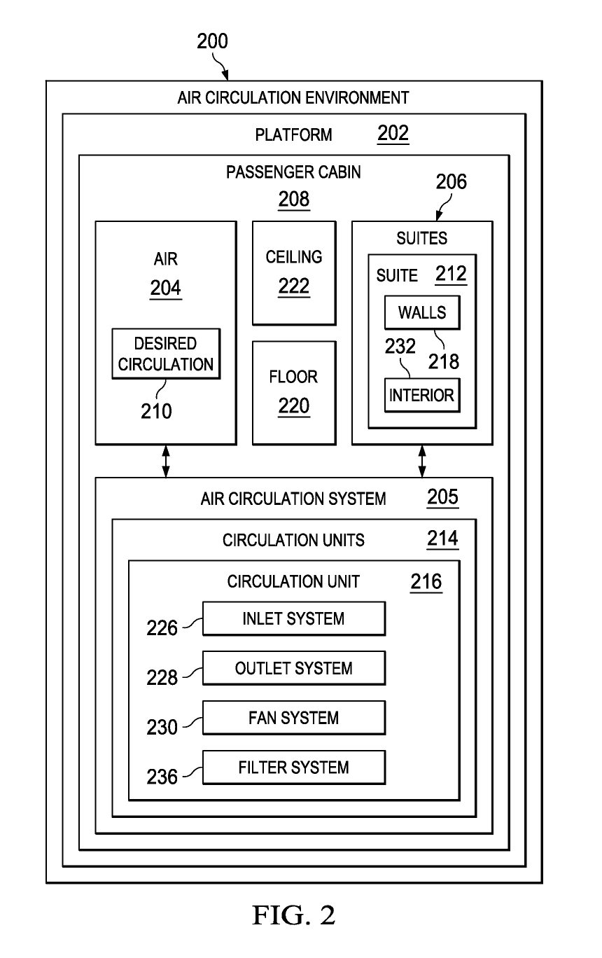

Turning next to FIG. 2, an illustration of a block diagram of an air circulation environment is depicted in accordance with an illustrative embodiment. As depicted, air circulation environment 200 includes platform 202 in which air 204 may circulate. In this illustrative example, air 204 may circulate within passenger cabin 208 in platform 202. In this illustrative example, platform 202 may take the form of aircraft 100 illustrated in FIG. 1.

In the illustrative examples, the circulation of air 204 may be facilitated by air circulation system 205. In this illustrative example, air circulation system 205 may be associated with suites 206 in passenger cabin 208. With air circulation system 205, desired circulation 210 of air 204 may occur within passenger cabin 208. Desired circulation 210 may be a circulation of air 204 such that passenger cabin 208 may reduce or avoid stagnant air, temperature stratification, or other undesirable conditions within suite 212, other suites in suites 206, or other areas within passenger cabin 208 that may result in an undesired experience for passengers.

In one illustrative example, air circulation system 205 may be implemented in suite 212 within suites 206. In particular, air circulation system 205 may comprise circulation units 214. For example, circulation unit 216 in circulation units 214 may be associated with suite 212.

When one component is “associated” with another component, the association is a physical association in the depicted examples. For example, a first component may be considered to be associated with a second component by being secured to the second component, bonded to the second component, mounted to the second component, welded to the second component, fastened to the second component, and/or connected to the second component in some other suitable manner. The first component also may be connected to the second component using a third component. The first component may also be considered to be associated with the second component by being formed as part of and/or an extension of the second component.

As depicted, suite 212 has walls 218 extending upward from floor 220 of passenger cabin 208 without reaching ceiling 222 of passenger cabin 208. In other words, an open area is present between top of walls 218 and ceiling 222 in these illustrative examples.

In the illustrative example, air circulation system 205 includes a number of different components. For example, air circulation system 205 includes inlet system 226, outlet system 228, and fan system 230.

Inlet system 226 is configured to receive air 204 in passenger cabin 208 in a location outside of suite 212. A part of inlet system 226 is in the location outside of suite 212 to receive air 204 in the location outside of suite 212.

Outlet system 228 is configured to output air 204 received by inlet system 226 into interior 232 of suite 212. Fan system 230 is configured to cause a movement of air 204 into inlet system 226 from outside of suite 212. Fan system 230 is further configured to move air 204 received through inlet system 226 out of outlet system 228 into interior 232 of suite 212.

As another illustrative example, circulation unit 216 also may include other components in addition to or in place of the ones illustrated. For example, circulation unit 216 also may include filter system 236.

Filter system 236 may be implemented using a number of different components. For example, filter system 236 may include an air filter configured to remove particles such as dust, pollen, mold, and bacteria from the air. In some illustrative examples, the air filter may also be a chemical air filter that includes a catalyst to remove various volatile organic compounds or ozone. In still other illustrative examples, filter system 236 also may include an ultraviolet light unit configured to render bacteria and other undesired particles inert.

In these illustrative examples, the movement of air 204 by circulation unit 216 may cause air 204 in interior 232 of suite 212 to move upward in suite 212. This movement of air 204 in suite 212 may be upward and over walls 218. This movement of air 204 may cause air 204 in suite 212 to mix with air 204 outside of suite 212 in passenger cabin 208. In this manner, desired circulation 210 of air 204 may occur within passenger cabin 208.

Thus, with the use of air circulation system 205 and, in particular, circulation units 214, desired circulation 210 may occur within passenger cabin 208. Desired circulation 210 may occur even with the presence of suites 206 blocking portions of passenger cabin 208.

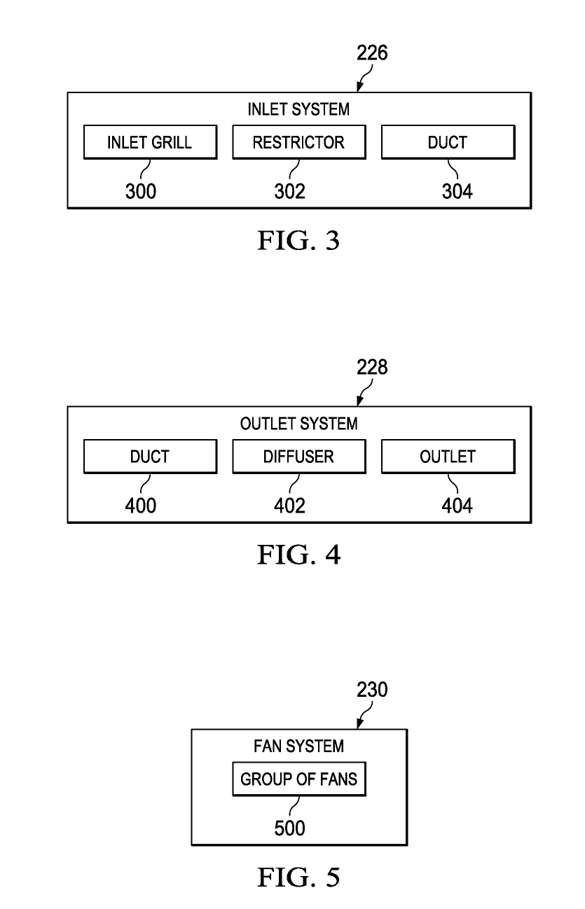

Turning next to FIG. 3, an illustration of an inlet system is depicted in accordance with an illustrative embodiment. An illustration of components that may be used to implement inlet system 226 in FIG. 2 is shown in this figure.

As depicted, inlet system 226 includes a number of different components. In one illustrative example, inlet system 226 includes inlet grill 300, restrictor 302, and duct 304.

Inlet grill 300 is located on a wall in walls 218 outside of suite 212. Inlet grill 300 provides an opening to receive air 204 in FIG. 2. In these illustrative examples, the area of inlet grill 300 is shaped such that movement of air 204 into inlet grill 300 from the main passenger aisle of platform 202 is substantially imperceptible to a person near inlet grill 300. In other words, inlet grill 300 is shaped such that a draft is not felt by persons in the main passenger aisle of platform 202.

As depicted, restrictor 302 is connected to inlet grill 300. In these illustrative examples, restrictor 302 is configured to connect inlet grill 300 to duct 304.

Duct 304 is a channel that provides a connection from restrictor 302 to fan system 230 in FIG. 2. In these depicted examples, duct 304 is smaller than inlet grill 300 in platform 202. As a result, an increase in velocity of air 204 as it passes through restrictor 302 into duct 304 occurs. The smaller size may be result of space restrictions in platform 202.

Turning next to FIG. 4, an illustration of an outlet system is depicted in accordance with an illustrative embodiment. An illustration of components that may be used to implement outlet system 228 in FIG. 2 is shown in this figure.

As depicted, outlet system 228 includes a number of different components. For example, outlet system 228 includes duct 400, diffuser 402, and outlet 404. Duct 400 is configured to be connected to fan system 230 in FIG. 2. Duct 400 is also connected to diffuser 402 in this illustrative example. Diffuser 402 is configured to reduce the velocity of air 204 received through duct 400 from fan system 230 in FIG. 2.

Outlet 404 is an opening that is located inside suite 212. Outlet 404 may take various forms. For example, outlet 404 may take the form of a grill, nozzle, or some other suitable type of opening.

In these illustrative examples, diffuser 402 is configured to reduce the velocity of air 204 entering suite 212 as air 204 is output from outlet 404. This reduction in the velocity of air 204 may be such that the movement of air 204 in suite 212 is substantially imperceptible to a person in suite 212.

In the illustrative examples, the velocity of air 204 in suite 212 may be selected to avoid a feeling of draftiness by a passenger in suite 212. For example, the velocities may be selected to avoid a feeling of draftiness on ankles, wrists, head, or other body parts of a passenger.

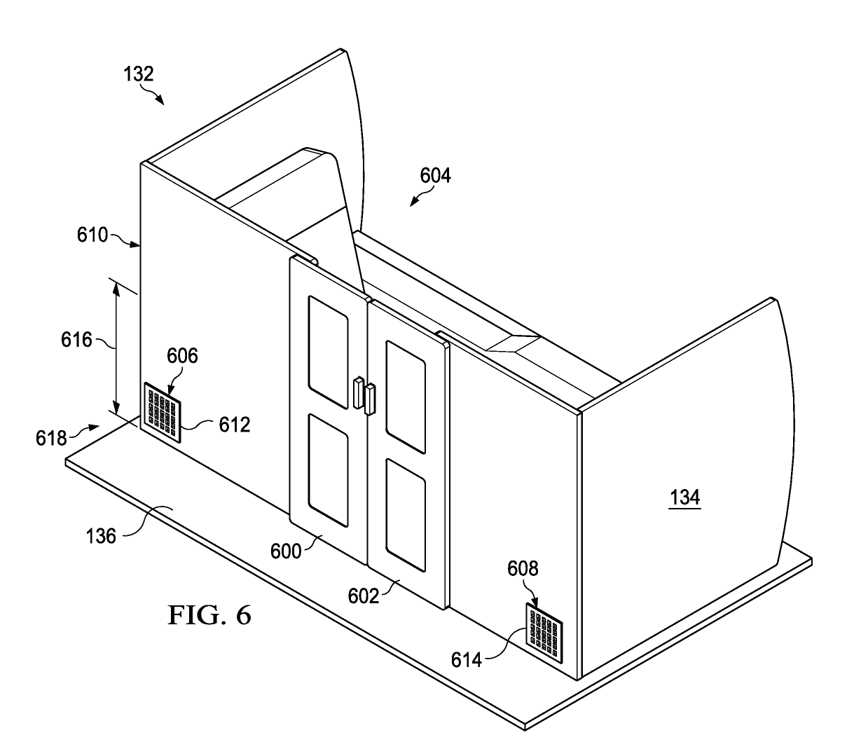

Turning next to FIG. 5, an illustration of a fan system is depicted in accordance with an illustrative embodiment. An illustration of components that may be used to implement fan system 230 in FIG. 2 are shown in this figure.

In this illustrative example, fan system 230 is comprised of a group of fans 500. As used herein, “a group of”, when used with reference items, means one or more items. For example, group of fans 500 is one or more fans.

As depicted in these illustrative examples, a fan in group of fans 500 may be a fan that has a brushless motor. Further, the fan may be selected to avoid generating undesired noise, fumes, smoke, or other undesired conditions when the fan does not operate as desired.

In these illustrative examples, group of fans 500 are comprised of the same type of fans or different fans when more than one fan is present in group of fans. Of course, different types of fans also may be used.

The illustration of air circulation environment 200 in the different components for air circulation system 205 in FIGS. 2-5 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although platform 202 has been described as taking the form of aircraft 100 in FIG. 1, platform 202 may take other forms. For example, platform 202 also may be selected from one of a surface ship, a cruise ship, a spacecraft, a train, or some other suitable type of platform.

In still other illustrative examples, one or more circulation units may be associated with suite 212 in addition to circulation unit 216. For example, suite 212 may include two circulation units, four circulation units, or some other number of circulation units. The number of circulation units used may depend on the airflow needed for desired circulation 210 within passenger cabin 208.

With reference now to FIGS. 6-9, illustrations of a suite are depicted in accordance with an illustrative embodiment. In these illustrative examples, a more detailed illustration of suite 132 in passenger cabin 122 in FIG. 1 with two circulation units is shown.

Turning next to FIG. 6, an illustration of an exterior view of a suite is depicted in accordance with an illustrative embodiment. A more detailed illustration of suite 132 is shown in this view. As depicted, suite 132 also includes door 600 and door 602 to provide entry and exit from interior 604 of suite 132.

Additionally, suite 132 also has circulation unit 606 and circulation unit 608. A portion of the circulation units can be seen on exterior 610 of walls 134 in this view.

More specifically, inlet grill 612 in circulation unit 606 and inlet grill 614 in circulation unit 608 can be seen. As depicted, inlet grill 612 and inlet grill 614 are located on lower half 616 of exterior 610 of walls 134. In these illustrative examples, inlet grill 614 may be located on a wall in walls 134 that is adjacent to aisle 618 in passenger cabin 122.

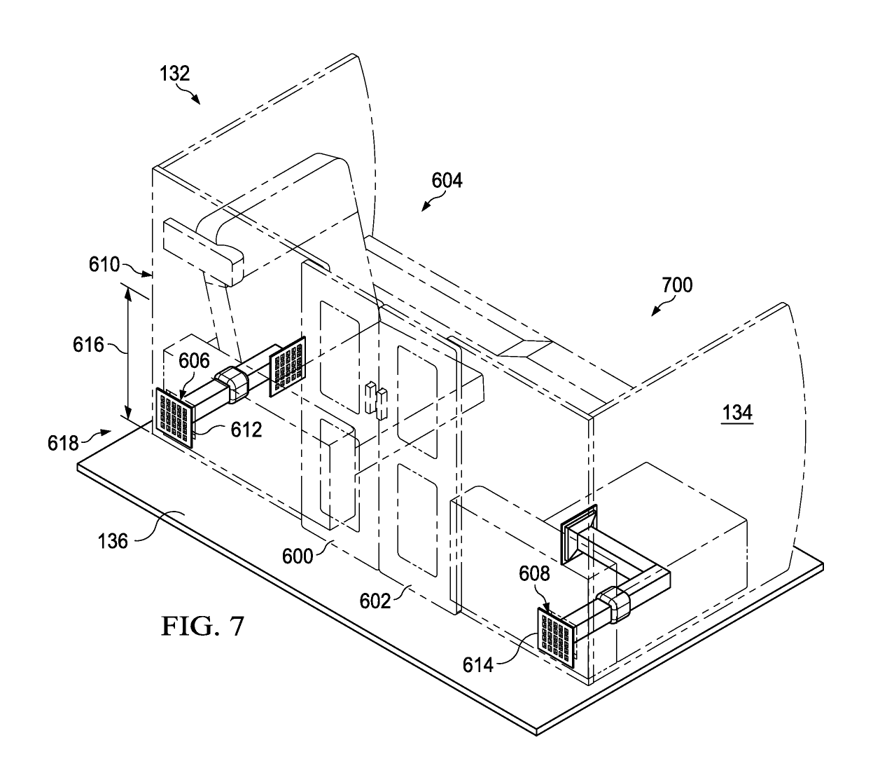

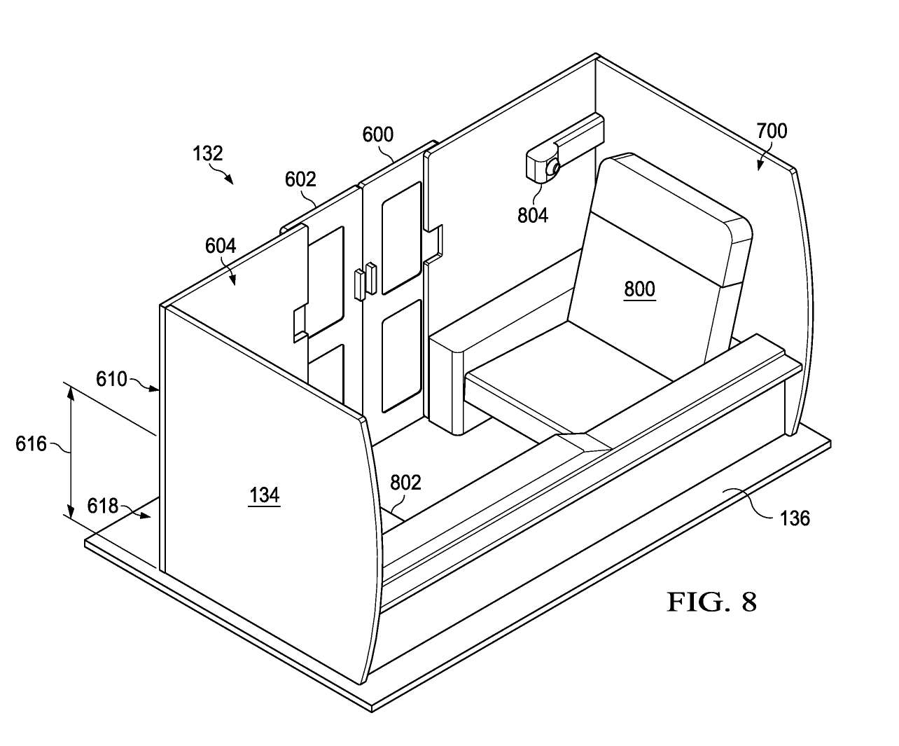

With reference now to FIG. 7, another illustration of an exterior view of a suite is depicted in accordance with an illustrative embodiment. In this depicted example, a transparent view of suite 132 is depicted. In this view of suite 132, monuments 700 within interior 604 of walls 134 of suite 132 can be seen. In particular, circulation unit 606 and circulation unit 608 are configured to be located within monuments 700. A monument is a structure. A monument may be attached to floor 136. A monument may be, for example, a seat, cabinetry, a galley, a credenza, or other structures that may be present in a platform such as an aircraft.

Turning next to FIG. 8, an illustration of an interior view of a suite is depicted in accordance with an illustrative embodiment. In this example, a view of interior 604 of suite 132 is shown. In this view, monuments 700 include seat 800 and bench 802.

Also seen in this view is gasper unit 804. Gasper unit 804 is configured to provide airflow to a passenger. In these illustrative examples, gasper unit 804 is not configured to aid in circulation of air within the passenger cabin.

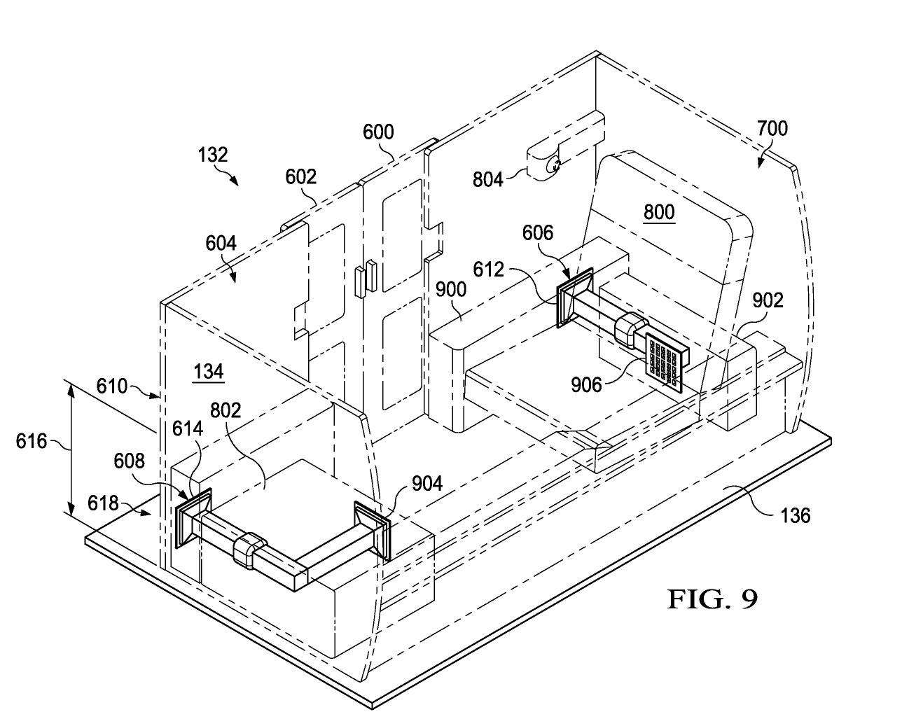

With reference now to FIG. 9, another illustration of an interior view of a suite is depicted in accordance with an illustrative embodiment. A transparent view of interior 604 of suite 132 is shown in this view. Circulation unit 606 and circulation unit 608 can be seen located within monuments 700.

As depicted in this view, circulation unit 608 is located within bench 802. Circulation unit 606 extends through armrest 900 in seat 800 and light unit 902 located behind seat 800. The location of circulation unit 608 within bench 802 reduces the visibility of circulation unit 608 to a passenger in suite 132. Further, the placement of circulation unit 606 extending through armrest 900 and light unit 902 is an example of an inconspicuous location in suite 132. In this manner, the aesthetics of suite 132 may be increased without a passenger seeing different components of circulation unit 606 and circulation unit 608.

As can be seen in this transparent view, outlet 904 in circulation unit 608 is located on bench 802. Outlet 906 in circulation unit 606 is located on light unit 902. Outlet 906 is located on lower half 616 of walls 134 within interior 604 of suite 132.

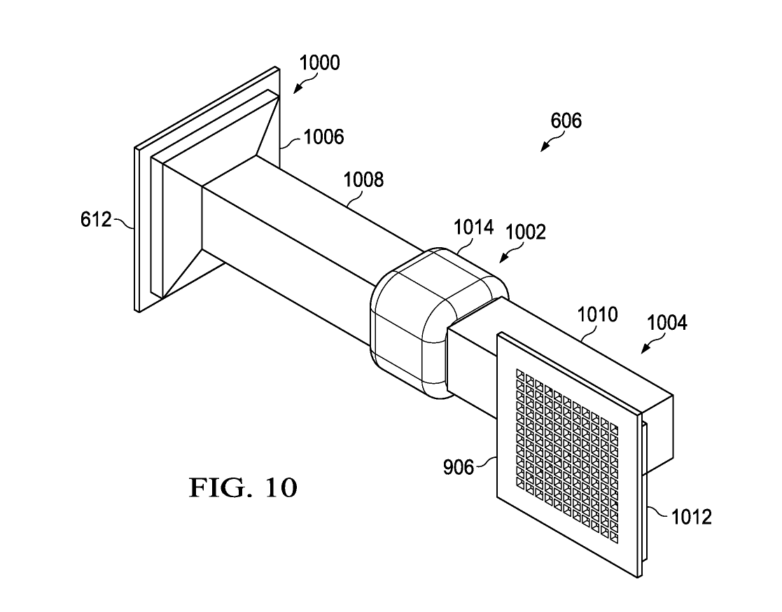

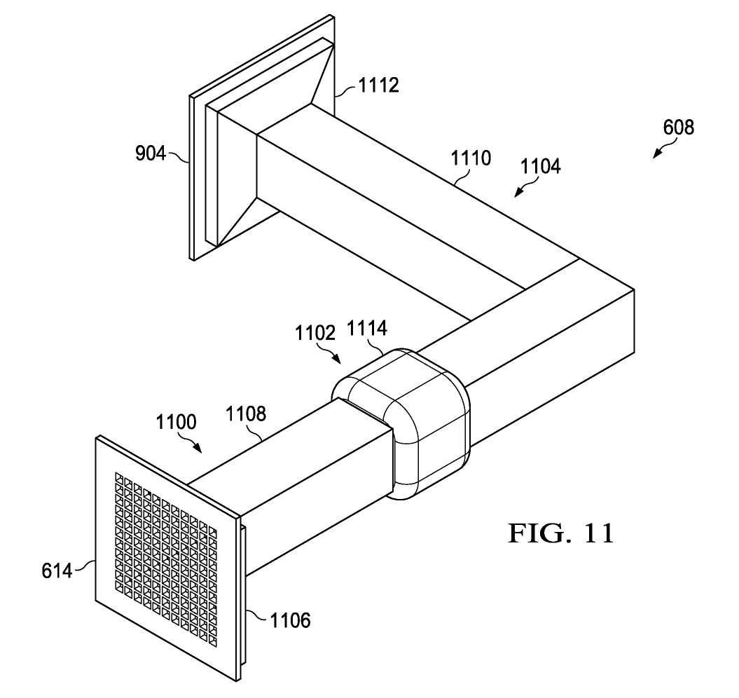

FIG. 10 and FIG. 11 are illustrations of circulation units that may be implemented in a suite in accordance with an illustrative embodiment. In FIG. 10, an illustration of a circulation unit is depicted in accordance with an illustrative embodiment. In this depicted example, an isometric view of circulation unit 606 is shown.

Circulation unit 606 has inlet system 1000, fan system 1002, and outlet system 1004. Inlet system 1000 includes inlet grill 612, restrictor 1006, and duct 1008. Outlet system 1004 comprises duct 1010, diffuser 1012, and outlet 906.

As depicted, fan system 1002 comprises fan 1014. Fan 1014 is connected to duct 1008 in inlet system 1000 and duct 1010 in outlet system 1004 in this illustrative example.

Turning next to FIG. 11, another illustration of a circulation unit is depicted in accordance with an illustrative embodiment. An isometric view of circulation unit 608 is shown in this figure.

Circulation unit 608 is comprised of inlet system 1100, fan system 1102, and outlet system 1104. Inlet system 1100 includes inlet grill 614, restrictor 1106, and duct 1108. In this illustrative example, outlet system 1104 includes duct 1110, diffuser 1112, and outlet 904.

Fan system 1102 is comprised of fan 1114. Fan 1114 is connected to duct 1108 in inlet system 1100 and duct 1110 in outlet system 1104.

With the location of circulation unit 606 and circulation unit 608 in lower half 616 of suite 132, cooler air may be drawn into suite 132 as compared to placing these units in higher locations. Further, suites typically include multiple heat sources such as a video monitor, electronic boxes, seat actuators, armrest motors, in-flight entertainment systems (IFEs), and other devices that may generate heat. The cool air may be used to displace hot-air that rises in the suites in these illustrative examples.

Illustrations of suite 132, circulation unit 606 and circulation unit 608 are not meant to imply limitations to the manner in which other illustrative embodiments may be implemented. For example, although two circulation units are illustrated, other numbers of circulation units may be used. In one illustrative example, only a single circulation unit may be used. In other examples, three or more circulation units may be associated with suite 132.

As another illustrative example, the length and shape of the ducts also may vary. Although the ducts are shown having a square cross-section, other ducts may have other shapes. For example, the cross-section may be rectangular, circular, oval, or some other suitable shape.

In still other illustrative examples, a circulation unit may have more than one inlet or more than one outlet depending on the particular implementation. For example, two inlets may have ducts that connect to a fan. As another illustrative example, a filter system also may be included in one or more of the circulation units. The filter system may be included to remove particles or render biological particles in the air inert. The filter system may include, for example, an air filter, and ultraviolet light, and other suitable types of filter systems.

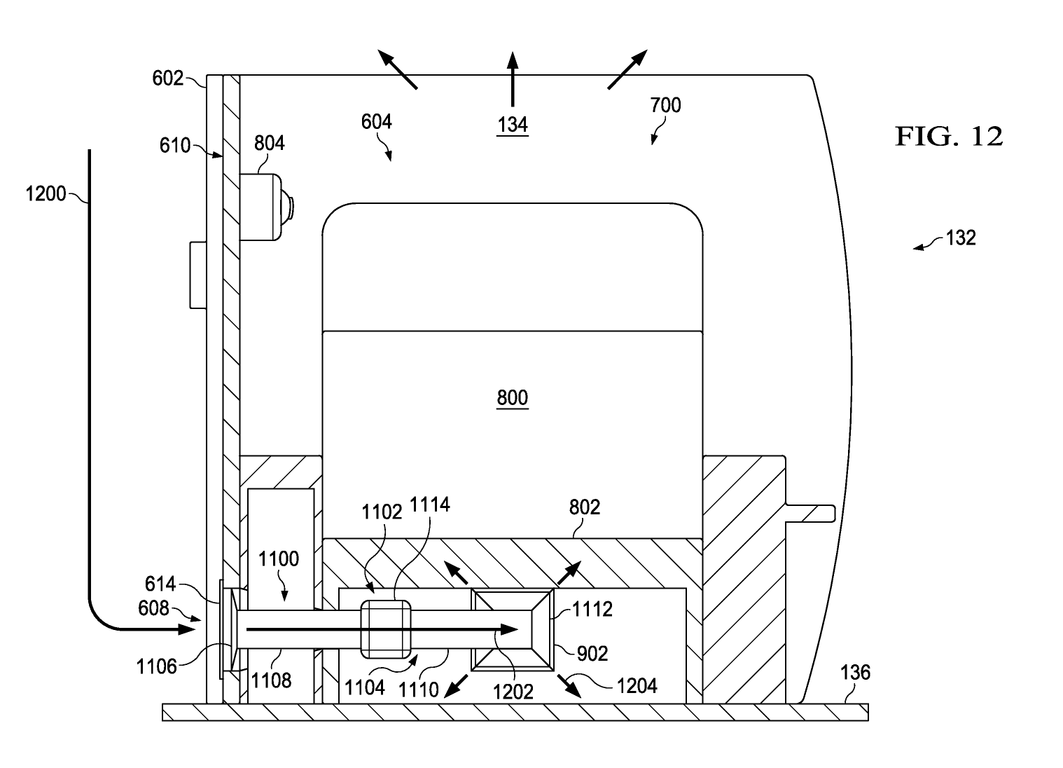

Turning now to FIG. 12, a cross-sectional view of a suite within an aircraft is depicted in accordance with an illustrative embodiment. In this depicted example, a cross-sectional view of suite 132 is taken along lines 12-12 in FIG. 1.

In this cross-sectional view, air may flow in the direction of arrow 1200 through inlet grill 614 into circulation unit 608. This airflow may pass through restrictor 1106 and duct 1108 to reach fan 1114.

As can be seen in this particular example, the air may then flow through duct 1110 to diffuser 1112 as depicted by arrow 1202. The air then flows out of outlet 908 into interior 604 of suite 132 as shown by arrows 1204. The air may then flow upward over the tops of walls 134 to mix with cabin air outside of suite 132 in passenger cabin 122.

The different components shown in FIGS. 1 and 6-12 may be combined with components in FIGS. 2-5, used with components in FIGS. 2-5, or a combination of the two. Additionally, some of the components in FIGS. 1 and 6-12 may be illustrative examples of how components shown in block form in FIGS. 2-5 can be implemented as physical structures.

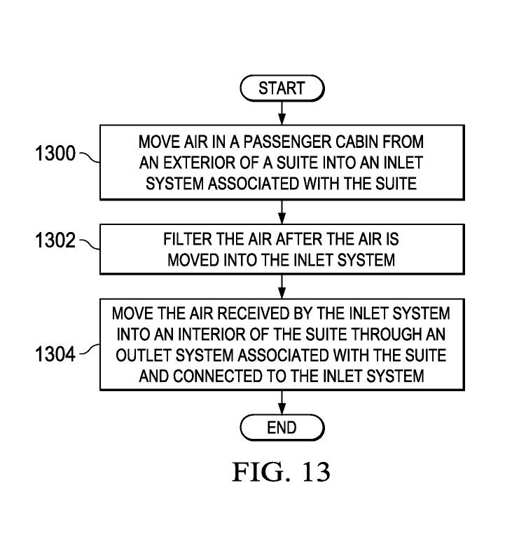

Turning next to FIG. 13, an illustration of a flowchart of a process for circulating air in a passenger cabin is depicted in accordance with an illustrative embodiment. The process illustrated in FIG. 13 may be implemented in air circulation environment 200 in FIG. 2. For example, one or more of the different operations in this flowchart may be implemented using one or more circulation units 214 in air circulation system 205.

The process begins by moving air in a passenger cabin from an exterior of a suite into an inlet system associated with the suite (operation 1300). The air is filtered after the air is moved into the inlet system (operation 1302). The air received by the inlet system is moved into an interior of the suite through an outlet system associated with the suite and connected to the inlet system (operation 1304) with the process terminating thereafter. In this illustrative example, the inlet system is indirectly connected to the outlet system by a fan system.

The different operations may cause a desired circulation of air within the passenger cabin. This process may be performed for one or more suites located in the passenger cabin.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent a module, a segment, a function, and/or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. For example, the filtering in operation 1302 may be amended in some steps.

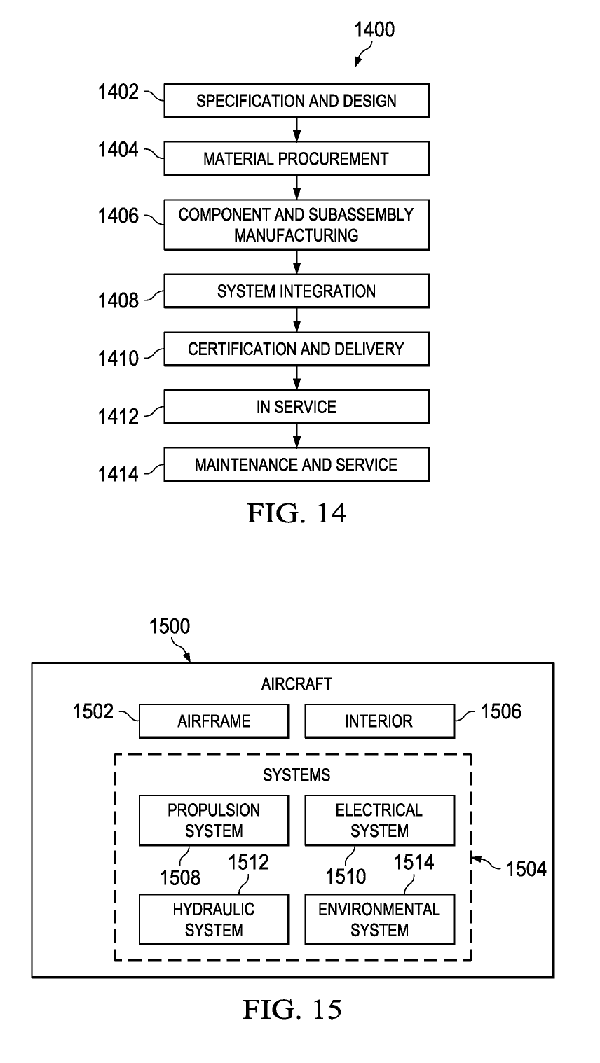

Illustrative embodiments of the disclosure may be described in the context of aircraft manufacturing and service method 1400 as shown in FIG. 14 and aircraft 1500 as shown in FIG. 15. Turning first to FIG. 14, an illustration of an aircraft manufacturing and service method is depicted in accordance with an illustrative embodiment. During pre-production, aircraft manufacturing and service method 1400 may include specification and design 1402 of aircraft 1500 in FIG. 15 and material procurement 1404.

During production, component and subassembly manufacturing 1406 and system integration 1408 of aircraft 1500 in FIG. 15 takes place. Thereafter, aircraft 1500 in FIG. 15 may go through certification and delivery 1410 in order to be placed in service 1412. While in service 1412 by a customer, aircraft 1500 in FIG. 15 is scheduled for routine maintenance and service 1414, which may include modification, reconfiguration, refurbishment, and other maintenance or service.

Each of the processes of aircraft manufacturing and service method 1400 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 15, an illustration of an aircraft is depicted in which an illustrative embodiment may be implemented. In this example, aircraft 1500 is produced by aircraft manufacturing and service method 1400 in FIG. 14 and may include airframe 1502 with systems 1504 and interior 1506. Examples of systems 1504 include one or more of propulsion system 1508, electrical system 1510, hydraulic system 1512, and environmental system 1514. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1400 in FIG. 14. One or more illustrative embodiments may be implemented using system integration 1408 to install circulation units for a circulation system in suites in a passenger cabin in aircraft 1500. Additionally, one or more illustrative embodiments may operate during in-service 1412 to provide desired air circulation within aircraft 1500. Further, one or more illustrative embodiments may be implemented during maintenance and service 1414. For example, circulation units may be added to suites in an aircraft. Circulation units may be installed when suites are installed during maintenance, refurbishment, upgrades, or other operations during maintenance and service 1414.

Thus, one or more illustrative embodiments may provide a more natural desired airflow of air in the passenger cabin. The different illustrative embodiments do not have the complexity of environmental systems that draw air from outside of the aircraft. Instead, the circulation system in the illustrative embodiments may provide a desired flow of air in the cabin through circulation units that may be associated with suites. These circulation units may be installed in existing and new suites. Further, with the use of circulation units, the need for louvers in the doors and gasper units may be reduced or eliminated.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. An air circulation system for a passenger cabin, the air circulation system comprising:
a suite having walls extending upward from a floor of the passenger cabin without reaching a ceiling of the passenger cabin; and
a circulation unit comprising an inlet system configured to receive air in the passenger cabin in a location outside of the suite; an outlet system configured to output the air received by the inlet system into an interior of the suite; and a fan system configured to cause a movement of the air into the inlet system from outside of the suite and out of the outlet system into the interior of the suite, wherein the air moves upwards in the suite and over the walls and wherein the air moving over the walls causes a desired circulation of the air within the passenger cabin.

2. The air circulation system of claim 1, wherein the circulation unit further comprises:
a filter system.

3. The air circulation system of claim 1, wherein the inlet system comprises:
an inlet grill;
a restrictor; and
a duct configured to be connected to the fan system.

4. The air circulation system of claim 1, wherein the outlet system comprises:
a duct configured to be connected to the fan system;
a diffuser; and
an outlet.

5. The air circulation system of claim 3, wherein the inlet grill is located on a wall in the walls that is adjacent to an aisle.

6. An apparatus comprising:
an inlet system configured to receive air in a passenger cabin of an aircraft in a location outside of a suite;
an outlet system configured to output the air received by the inlet system into an interior of the suite; and
a fan system configured to cause a movement of the air into the inlet system and out of the outlet system, wherein the movement of the air causes a desired circulation of the air in the passenger cabin.

7. The apparatus of claim 6 further comprising:
a filter system.

8. The apparatus of claim 6, wherein the inlet system comprises:
an inlet grill;
a restrictor; and
a duct configured to be connected to the fan system.

9. The apparatus of claim 8, wherein the inlet grill is located on a lower half of an exterior of walls of the suite.

10. The apparatus of claim 6, wherein the outlet system comprises:
a duct configured to be connected to the fan system;
a diffuser; and
an outlet.

11. The apparatus of claim 10, wherein the outlet is located on a lower half of an interior of walls of the suite.

12. The apparatus of claim 6, wherein the fan system comprises a group of fans.

13. The apparatus of claim 6, wherein the desired circulation of the air in the passenger cabin is movement of the air upward in the suite, wherein the air in the suite mixes with the air outside of the suite.

14. The apparatus of claim 6, wherein the movement of the air is substantially imperceptible to a person in the suite.

15. The apparatus of claim 6, wherein the suite comprises:
a plurality of walls extending upward from a floor of the passenger cabin without reaching a ceiling of the passenger cabin.

16. The apparatus of claim 6, wherein the passenger cabin is located in a platform selected from one of an aircraft, a surface ship, a cruise ship, a spacecraft, and a train.

17. A method for circulating air in a passenger cabin, the method comprising:
moving the air in the passenger cabin from an exterior of a suite into an inlet system associated with the suite; and
moving the air received by the inlet system into an interior of the suite through an outlet system associated with the suite, wherein a movement of the air causes a desired circulation of the air in the passenger cabin.

18. The method of claim 17 further comprising:
filtering the air after the air is moved into the inlet system and before the air is moved into the suite through the outlet system.

19. The method of claim 17, wherein the inlet system is located on a wall of the suite that is adjacent to an aisle.

20. The method of claim 17, wherein the passenger cabin is located in a platform selected from one of an aircraft, a surface ship, a cruise ship, a spacecraft, and a train.
